(19) United States
(12) Patent Application Publication
(10) Pub. No.: US 2014/0375924 A1
(43) Pub. Date: Dec. 25, 2014

(54) DISPLAY DEVICE

(71) Applicant: Mitsubishi Electric Corporation, Tokyo (JP)

(72) Inventor: Masanobu SAIKI, Tokyo (JP)

(73) Assignee: MITSUBISHI ELECTRIC CORPORATION, Tokyo (JP)

(21) Appl. No.: 14/300,593

(22) Filed: Jun. 10, 2014

(30) Foreign Application Priority Data
Jun. 19, 2013 (JP) 2013-128299

(51) Int. Cl. G02F 1/1335

(52) U.S. Cl. CPC G02F 1/133608; G02F 2001/133628
USPC 349/58

(57) ABSTRACT

A display device includes a display part, a backlight part, and a fixing housing. The backlight part has a light source and a backlight housing in which the light source is located on an inner surface of a side surface portion. The fixed housing has an opening portion exposing a display surface of the display part and fixes the display part and the backlight part to each other. The fixed housing is not in contact with a light-source disposed portion in the side surface portion of the backlight housing, the light-source disposed portion having the light source located thereon.

### BACKGROUND OF THE INVENTION

1. Field of the Invention

The present invention relates to a display device.

2. Description of the Background Art

As disclosed in Japanese Patent Application Laid-Open No. 6-130368 (1994), Japanese Patent Application Laid-Open No. 7-318932 (1995), and Japanese Patent Application Laid-Open No. 2003-114431, various techniques related to display devices provided with display parts that are irradiated with light from light sources have been developed.

In the display devices as mentioned above, when heat generated by the light sources is transmitted to the display parts, display characteristics of the display parts may deteriorate.

### SUMMARY OF THE INVENTION

It is an object of the present invention to make heat generated by a light source more difficult to be transmitted to a display part, the display part provided in a display device being irradiated with light from the light source.

A display device according to the present invention includes a display part, a backlight part that has a light source and a backlight housing in which the light source is located on an inner surface of a side surface portion, and a fixing housing that has an opening portion exposing a display surface of the display part and fixes the display part and the backlight part to each other. The fixing housing is not in contact with a light-source disposed portion in the side surface portion of the backlight housing, the light-source disposed portion having the light source located thereon.

A display device according to the present invention includes a display part, a backlight part that has a light source and a backlight housing in which the light source is located on an inner surface, a fixing housing that has an opening portion exposing a display surface of the display part and fixes the display part and the backlight part to each other, and a heat insulator located between the fixing housing and the backlight housing.

The present invention can make heat generated by the light source more difficult to be transmitted to the display part.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a display device according to a first preferred embodiment;

FIG. 2 is an exploded perspective view showing the display device according to the first preferred embodiment;

FIGS. 3 and 4 are cross sectional views of the display device according to the first preferred embodiment;

FIG. 5 is a cross sectional view of a display device;

FIG. 6 is a cross sectional view of the display device according to the first preferred embodiment;

FIG. 7 is a cross sectional view of a display device according to a first modification of the first preferred embodiment;

FIG. 8 is a cross sectional view of a display device according to a second modification of the first preferred embodiment;

FIG. 9 is a diagram showing a fixing housing side surface portion according to the second modification of the first preferred embodiment;

FIG. 10 is a cross sectional view of a display device according to a third modification of the first preferred embodiment;

FIG. 11 is a diagram showing a fixing housing side surface portion according to a third modification of the first preferred embodiment;

FIG. 12 is a diagram showing a display device according to a second preferred embodiment;

FIG. 13 is a cross sectional view of the display device according to the second preferred embodiment; and

FIGS. 14, 15, and 16 are diagrams showing modifications of the display device according to the second preferred embodiment.

### DESCRIPTION OF THE PREFERRED EMBODIMENTS

### First Preferred Embodiment

<As to Display Device>

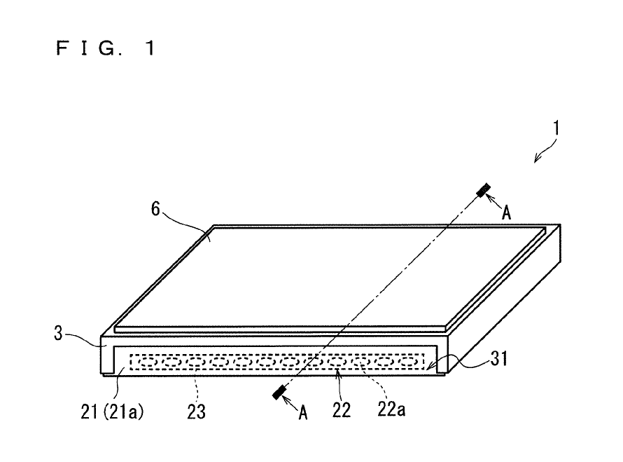

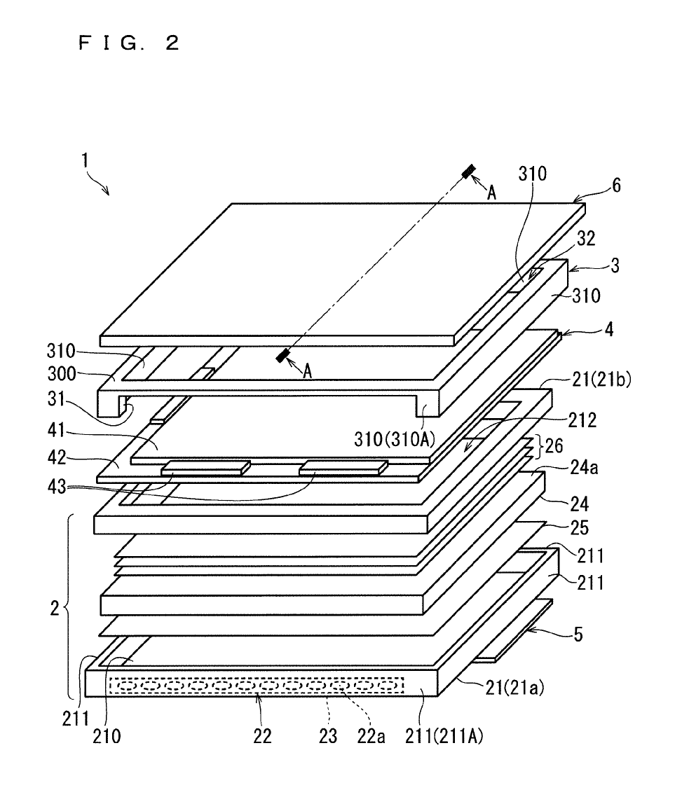

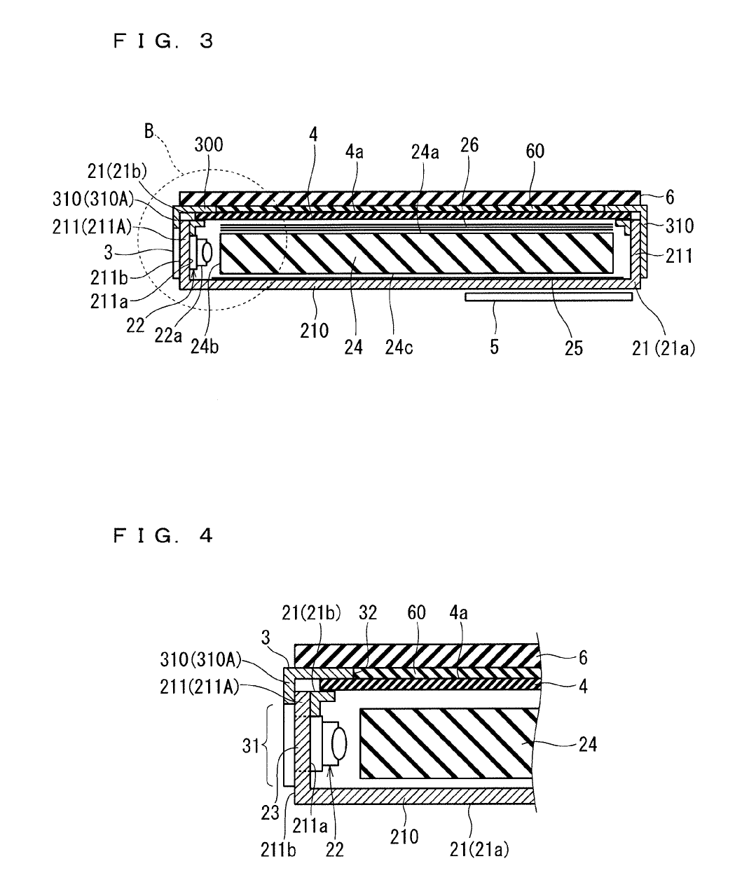

FIG. 1 is a diagram showing a display device 1 according to a first preferred embodiment. FIG. 2 is an exploded perspective view of the display device 1. FIG. 3 is a cross sectional view of the display device 1 taken along an A-A line shown in FIGS. 1 and 2. FIG. 4 is an enlarged view of a portion B shown in FIG. 3. In addition, in FIG. 4, a reflective sheet 25 and an optical sheet 26 which are shown in FIG. 3 are omitted.

The display device 1 is, for example, a thin and lightweight display device. The display device 1 is used as a display for a cellular phone, a display for a personal computer, a display for various devices for industrial use, a display for an in-vehicle device, a display for a hand-held terminal device, or a display for an advertising display device, for example.

As shown in FIGS. 1 and 2, the display device 1 includes a backlight part 2, a fixing housing 3, a display part 4, a circuit substrate 5, and a cover member 6 covering a display surface of the display part 4. The cover member 6 is, for example, a protective member for protecting the display part 4 or a touch panel.

In the display device 1, the backlight part 2 disposed at the back of the display part 4 irradiates the display part 4. Then, the circuit substrate 5 controls an electric signal to the display part 4 in response to an input signal (input image) in order to adjust the amount of transmitted light in each pixel of the display part 4. Consequently, the input image is displayed on the display surface of the display part 4. Components forming the display device 1 will be described below.

<Backlight Part>

The backlight part 2 includes a backlight housing 21, a light source 22, a light guide body 24, a reflective sheet 25, and an optical sheet 26. The backlight part 2 according to the preferred embodiment is, for example, an edge incident light type (side light type) backlight part in which the light source 22 is disposed on the side of the light guide body 24.

The backlight housing 21 has a backlight back housing 21a and a backlight front housing 21b. The backlight housing 21 holds other components, such as the light guide body 24, forming the backlight part 2 and the display part 4 inside of the backlight housing 21. Moreover, the circuit substrate 5 is mounted on the outer surface of the backlight back housing 21a. The backlight back housing 21a and the backlight front housing 21b are fixed to each other in a structure of a hook or with a screw. In the preferred embodiment, the backlight housing 21 is formed of two members of the backlight back housing 21a and the backlight front housing 21b, but it may be formed of one member.

The backlight back housing 21a is in a box shape having an upper surface with an opening and has a bottom surface portion 210 and four side surface portions 211. As shown in FIGS. 3 and 4, the light source 22 is disposed in an inner surface 211a of one of the side surface portions 211 of the backlight back housing 21a. The light source 22 in the preferred embodiment is formed of, for example, a plurality of light-emitting elements 22a. Each of the light-emitting elements 22a is, for example, a light emitting diode (LED) serving as a point source. The plurality of light-emitting elements 22a are arranged in one line along a longitudinal direction of the side surface portion 211 in which the light-emitting elements 22a are disposed. Hereinafter, a portion in which the light source 22 is disposed in the side surface portion 211 of the backlight back housing 21a is referred to as a light-source disposed portion 23 (see FIGS. 1, 2, and 4). Furthermore, among the four side surface portions 211 of the backlight back housing 21a, the side surface portion 211 in which the light source 22 is disposed may be referred to as a side surface portion 211A.

Preferably, the backlight back housing 21a is formed of a metal material having a high thermal conductivity (for example, aluminum and aluminum alloy). The backlight back housing 21a is formed of the metal material having the high thermal conductivity, so that the backlight back housing 21a can effectively transmit heat generated by the light source 22 from the light-source disposed portion 23 to a portion other than the light-source disposed portion 23 (for example, the bottom surface portion 210 of the backlight back housing 21a). Therefore, the heat generated by the light source 22 can be properly dissipated. Thus, the heat generated by the light source 22 can be suppressed to be confined in the backlight part 2.

As shown in FIG. 2, the backlight front housing 21b is in a frame shape and has an opening portion 212 for leading the light outputted from the light guide body 24 to the display part 4 side. As shown in FIG. 3, the display part 4 in a state of being positioned is fixed to an upper surface of the backlight front housing 21b having the frame shape. As materials for the backlight front housing 21b, metal materials such as aluminum, stainless steel, and iron, or resin materials such as polycarbonate (PC), and acrylonitrile butadiene styrene (ABS) may be used.

The light guide body 24 is in a plate shape, for example. The light source 22 faces one of the side surfaces of the light guide body 24, and the one of the side surfaces is an incident surface 24b (see FIG. 3) on which the light outputted from the light source 22 is incident. The light incident from the incident surface 24b is propagated through the inside of the light guide body 24 and outputted from an emission surface 24a being the upper surface of the light guide body 24. The light guide body 24 is formed of, for example, a transparent acrylic resin, a polycarbonate resin, a glass, or the like. At least one of the emission surface 24a and an anti-emission surface 24c (bottom surface) of the light guide body 24 is provided with a dot pattern or a prism shape for a scattering of light to adjust an in-plane strength distribution and an output (emission) direction of output light (emission light).

The reflective sheet 25 is located so as to cover the anti-emission surface 24c of the light guide body 24. The reflective sheet 25 directs light leaking from the anti-emission surface 24c of the light guide body 24 to the light guide body 24.

The optical sheet 26 is located so as to cover the emission surface 24a of the light guide body 24. The optical sheet 26 adjusts a distribution and a spread of light outputted from the emission surface 24a. The optical sheet 26 is formed of a combination of a lens sheet for the purpose of condensing light, a diffusion sheet for the purpose of making luminance uniform, and a viewing angle adjustment sheet that adjusts luminance in a direction of a viewing angle.

The backlight part 2 with this configuration reflects and diffuses light outputted from the light source 22 to function as a plane light source. Then, the backlight part 2 irradiates the display part 4 from its back surface.

To increase the amount of light outputted from the backlight part 2, in other words, to increase the luminance of the backlight part 2, for example, the number of the plurality of light-emitting elements 22a forming the light source 22 is increased or a driving current for driving each light-emitting element 22a is increased. If the amount of light outputted from the backlight part 2 is increased, it is easier to see the display of the display part 4 even in a case where the display device 1 is used outside, for example.

<Display Part>

The display part 4 is a transmissive or translucent liquid crystal panel that performs a display using birefringence of a liquid crystal. As shown in FIG. 2, the display part 4 includes a first substrate 41, a second substrate 42, and drive ICs 43 for driving the display part 4.

The first substrate 41 and the second substrate 42 each includes an insulating substrate formed of a glass or the like. A color filter, a light-shielding layer, a counter electrode, and the like are formed on the insulating substrate of the first substrate 41. A thin film transistor being a switching element, a pixel electrode, and the like are formed on the insulating substrate of the second substrate 42. The drive ICs 43 are located on an outer periphery of the upper surface of the second substrate 42. The drive ICs 43 may be located on a tape-shaped wiring material (such as a tape carrier package (TCP) and a chip on film (COF)) connected to the outer periphery of the upper surface of the second substrate 42.

The display part 4 is also provided with various members, which are not shown for the sake of brevity of diagrams, other than the first substrate 41, the second substrate 42, and the drive ICs 43. The first substrate 41 and the second substrate 42 are bonded to each other with a sealing material, a spacer interposing therebetween. The spacer provides a gap between the first substrate 41 and the second substrate 42. Liquid crystals are filled in the gap between the first substrate 41 and the second substrate 42.

Moreover, an inlet of the liquid crystals in the display part 4 is provided with a sealing material. The display part 4 is provided with an alignment film for aligning liquid crystals. The display part 4 is provided with polarizing plates on an outer surface of the first substrate 41 and an outer surface of the second substrate 42. The first substrate 41 of the display part 4 is provided with a color filter of RGB (red, green, and blue) for each pixel. Consequently, a color image is displayed on a display surface 4a (see FIGS. 3 and 4) of the display part 4. The display part 4 may display a monochrome image on the display surface 4a.

<Circuit Substrate>

A control circuit is mounted on the circuit substrate 5, and the control circuit controls the light source 22 and the display part 4. In the circuit substrate 5, for example, a copper pattern is formed on a substrate made of a glass epoxy or the like. On the substrate, electronic components are mounted by means of soldering.

As shown in FIGS. 2 and 3, in the display device 1 of the preferred embodiment, the circuit substrate 5 is disposed on the back surface of the backlight back housing 21a, and electronic components may be mounted on flexible printed circuits (FPCs) connected to the display part 4 to form the circuit substrate 5. To protect the circuit substrate 5 from an external pressure and static electricity, a metal protective cover made of metal such as aluminum, a stainless steel, and a galvanized steel plate or a protective cover made of a film-shaped thin resin such as polyethylene terephthalate (PET) may be provided. In a case where the metal protective cover is used, a resin sheet made of the PET or the like is preferably adhering to the surface of the protective cover on the circuit substrate 5 side such that the circuit substrate 5 and the electronic components mounted on the circuit substrate 5 are not electrically connected to the protective cover.

<Fixing Housing>

The fixing housing 3 is a frame-shaped member for fixing the backlight part 2 and the display part 4 to each other. The cover member 6 is provided on the fixing housing 3. The fixing housing 3 is formed of a metal material of a thin plate or a resin molded product. The fixing housing 3 is provided on the backlight part 2 so as to interpose the display part 4 between the fixing housing 3 and the backlight part 2. The fixing housing 3 is fixed to the backlight part 2 in a structure of a hook or with a screw.

As shown in FIG. 2, the fixing housing 3 has an upper surface portion 300 and four side surface portions 310. The upper surface portion 300 of the fixing housing 3 is provided with an opening portion 32. The fixing housing 3 is provided on the backlight part 2 such that the display surface 4a of the display part 4 is exposed from the opening portion 32 while the four side surface portions 310 are each in contact with the outer surfaces 211b of four side surface portions 211 of the backlight back housing 21a. At this time, a peripheral portion of the display part 4 is interposed between the upper surface portion 300 of the fixing housing 3 and the backlight front housing 21b. The cover member 6 is provided on the upper surface portion 300 of the fixing housing 3 so as to cover the opening portion 32. Hereinafter, the side surface portions 310 of the fixing housing 3 may be referred to as “fixing housing side surface portions 310.”

Among the four fixing housing side surface portions 310 of the fixing housing 3, the fixing housing side surface portion 310 (hereinafter, may be referred to as a “fixing housing side surface portion 310A”) covering the outer surface 211b of the side surface portion 211 A of the backlight back housing 21a has a notch portion 31. A portion in the fixing housing side surface portion 310A has the notch portion 31, the portion facing the light-source disposed portion 23. Consequently, the light-source disposed portion 23 is exposed from the notch portion 31 (see FIG. 1).

In this manner, the fixing housing side surface portion 310A has the notch portion 31, so that the fixing housing 3 is not in contact with the light-source disposed portion 23 in the side surface portion 211A of the backlight back housing 21a. Therefore, the heat generated by the light source 22 is difficult to be transmitted from the light-source disposed portion 23 to the fixing housing 3.

The fixing housing 3 may be formed of one member as in the preferred embodiment and may be formed of a combination of a plurality of members. The fixing housing 3 may be provided with a mounting part (screw, mounting hole, or the like) for mounting an end product in which the display device 1 is incorporated and the display device 1.

<Cover Member>

As described above, the cover member 6 is a protective member for protecting the display surface 4a or a touch panel. The protective member is formed of, for example, a glass or a plastic. The protective member prevents damage, deformation, abrasion, and soiling of the display surface 4a which are caused by the application of pressure to and contact with the display surface 4a of the display part 4. Print for the purpose of shielding light or a design may be added to the surface of the protective member or the peripheral portion of the back surface of the protective member.

In the touch panel, a circuit including a transparent circuit formed on a transparent substrate converts an operation of the touch panel by an operator (for example, a finger of an user) into an electric signal. The electric signal is inputted, through an output wiring portion connected to an end portion of the touch panel, into a control circuit of the end product in which the display device 1 is incorporated. The output wiring portion is achieved by a thin and flexible FPC to secure flexibility in connection, for example. However, the output wiring portion may be formed of a member different from the FPC if the member is equal in functions and characteristics to the FPC. Moreover, a transparent protective glass may be provided on the front of the touch panel.

In the example as mentioned above, the cover member 6 is provided on the fixing housing 3 and the display surface 4a of the display part 4. The display surface 4a is exposed from the opening portion 32 of the fixing housing 3. The cover member 6 is provided on the display surface 4a with an adhesive 60 made of a resin or the like. A technique for bonding the cover member 6 to the display surface 4a with the adhesive formed of the resin or the like is referred to as a “glass bonding.” The use of glass bonding allows for a reduction in an external light reflectance of the display surface 4a. Therefore, outdoor visibility of the display surface 4a can be improved. In this preferred embodiment, the cover member 6 is provided on the fixing housing 3 and the display surface 4a. However, the cover member 6 may be provided only on the fixing housing 3 or only on the display surface 4a. In addition, the cover member 6 may be provided on the display surface 4a with a double-sided adhesive tape or the like instead of the adhesive 60.

<As to Comparison Object Display Device>

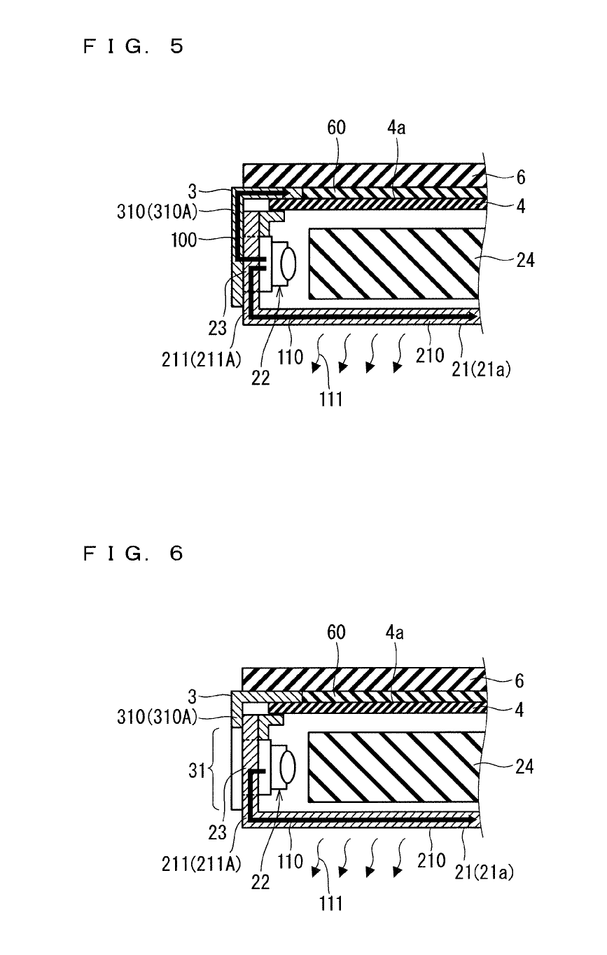

Herein, a display device compared to the display device 1 of the preferred embodiment (hereinafter, referred to as a “comparison object display device”) will be described. FIG. 5 is a cross sectional view of the comparison object display device, which corresponds to the cross sectional view of the display device 1 as shown in FIG. 4.

As shown in FIG. 5, in the comparison object display device, the fixing housing side surface portion 310A of the fixing housing 3 does not have the notch portion 31, the fixing housing side surface portion 310A being in contact with the side surface portion 211A of the backlight back housing 21a. Therefore, the fixing housing 3 is in contact with the light-source disposed portion 23 of the side surface portion 211A of the backlight back housing 21a. Consequently, as shown by an arrow 100 in FIG. 5, the heat generated by the light source 22 is directly transmitted from the light-source disposed portion 23 to the fixing housing 3 and subsequently transmitted to the display part 4. As a result, the temperature of the display part 4 increases. Particularly, the temperature of the peripheral portion in the display part 4 increases, the peripheral portion being in contact with the fixing housing 3. As a result, a liquid crystal phase transition easily occurs in the display part 4 and display characteristics of the display part 4 may deteriorate (for example, unevenness in luminance and color of display may occur). Moreover, the heat generated by the light source 22 is transmitted to the fixing housing 3 and also transmitted to the bottom surface portion 210 of the backlight back housing 21a as shown by an arrow 110. Then, the heat transmitted to the bottom surface portion 210 is dissipated to the outside as shown by arrows 111.

In this manner, when the fixing housing 3 and the light-source disposed portion 23 are in contact with each other, the heat generated by the light source 22 is easily transmitted to the display part 4 and the display characteristics of the display part 4 may deteriorate. Particularly, in a case where the high-luminance light source 22 is used, a large amount of heat is generated by the light source 22, so that the temperature of the display part 4 easily increases and the display characteristics of the display part 4 may further deteriorate. Furthermore, in a case where the cover member 6 is bonded to the display surface 4a with the adhesive 60, the double-sided adhesive tape, or the like, the heat transmitted to the display part 4 is difficult to be dissipated to the outside and the heat is easily confined in the display part 4. As a result, the display characteristics of the display part 4 may further deteriorate.

In contrast to this, in the display device 1 of the first preferred embodiment as shown in FIG. 6, the fixing housing side surface portion 310A of the fixing housing 3 has the notch portion 31 provided in the portion facing the light-source disposed portion 23, so that the fixing housing 3 is not in contact with the light-source disposed portion 23. Thus, heat can be suppressed to be directly transmitted to the fixing housing 3 from the light-source disposed portion 23. In other words, providing the notch portion 31 makes the heat generated by the light source 22 more difficult to be transmitted to the fixing housing 3. As a result, the heat is also difficult to be transmitted to the display part 4 being in contact with the fixing housing 3, and thus the deterioration of the display characteristics of the display part 4 due to the occurrence of the liquid crystal phase transition can be suppressed. In this case, the heat generated by the light source 22 is easily transmitted from the light-source disposed portion 23 of the backlight back housing 21a to the bottom surface portion 210 of the backlight back housing 21a (arrow 110) and easily dissipated from the bottom surface portion 210 (arrows 111). Moreover, the notch portion 31 is cut out of the fixing housing 3, so that the display device 1 can also be reduced in weight. The side surface portion 310 of the fixing housing 3 has the notch portion 31, and thus the notch portion 31 is kept out of the way even in a case where the cover member 6 is provided on the upper surface portion 300 of the fixing housing 3. In other words, providing the notch portion 31 can prevent a situation in which the cover member 6 is difficult to be provided on the fixing housing 3.

As shown in FIG. 4, if the cover member 6 is provided on the display surface 4a of the display part 4 and the heat is easily confined in the display part 4, the notch portion 31 can reduce the amount of heat transmitted to the display part 4, so that a rise in the temperature of the display part 4 can be suppressed. Thus, even if the cover member 6 such as the protective member and the touch panel is provided on the display surface 4a, the deterioration of the display characteristics of the display part 4 can be suppressed. Furthermore, the heat generated by the light source 22 is difficult to be transmitted to the fixing housing 3, and thus the heat is also difficult to be transmitted to the cover member 6. Therefore, a heat deformation or the like of the cover member 6 can be suppressed.

### Modifications of First Preferred Embodiment

Hereinafter, three modifications of the display device 1 according to the first preferred embodiment will be described. In the preferred embodiment as described above, the fixing housing side surface portion 310A has the notch portion 31, so that the fixing housing 3 and the light-source disposed portion 23 are not in contact with each other, and in the modifications as described below, another technique is used to prevent contact between the fixing housing 3 and the light-source disposed portion 23. The fixing housing 3 and the light-source disposed portion 23 are not in contact with each other, and thus the heat generated by the light source 22 is difficult to be transmitted to the fixing housing 3 similarly to the first preferred embodiment.

First, a first modification as shown in FIG. 7 will be described. FIG. 7 is a partial cross sectional view of the display device 1 according to the first modification. As shown in FIG. 7, in the display device 1 according to the first modification, the fixing housing side surface portion 310A of the fixing housing 3 faces the outer surface 211b of the side surface portion 211A of the backlight back housing 21a. To prevent contact between the fixing housing side surface portion 310A and the side surface portion 211A of the backlight back housing 21a, a gap 34 is provided between the fixing housing side surface portion 310A and the side surface portion 211A.

On the other hand, among the four fixing housing side surface portions 310 of the fixing housing 3, the three fixing housing side surface portions 310 other than the fixing housing side surface portion 310A are each in contact with the outer surfaces 211b of the three side surface portions 211 other than the side surface portion 211A among the four side surface portions 211 of the backlight back housing 21a, similarly to the first preferred embodiment.

In this manner, to prevent contact between the fixing housing side surface portion 310A and the side surface portion 211A of the backlight back housing 21a, the gap 34 is provided between the fixing housing side surface portion 310A and the side surface portion 211A, so that the heat generated by the light source 22 is more difficult to be transmitted to the fixing housing 3 than the first preferred embodiment. As a result, the heat is also difficult to be transmitted to the display part 4, and thus the deterioration of the display characteristics of the display part 4 due to the occurrence of the liquid crystal phase transition can be suppressed.

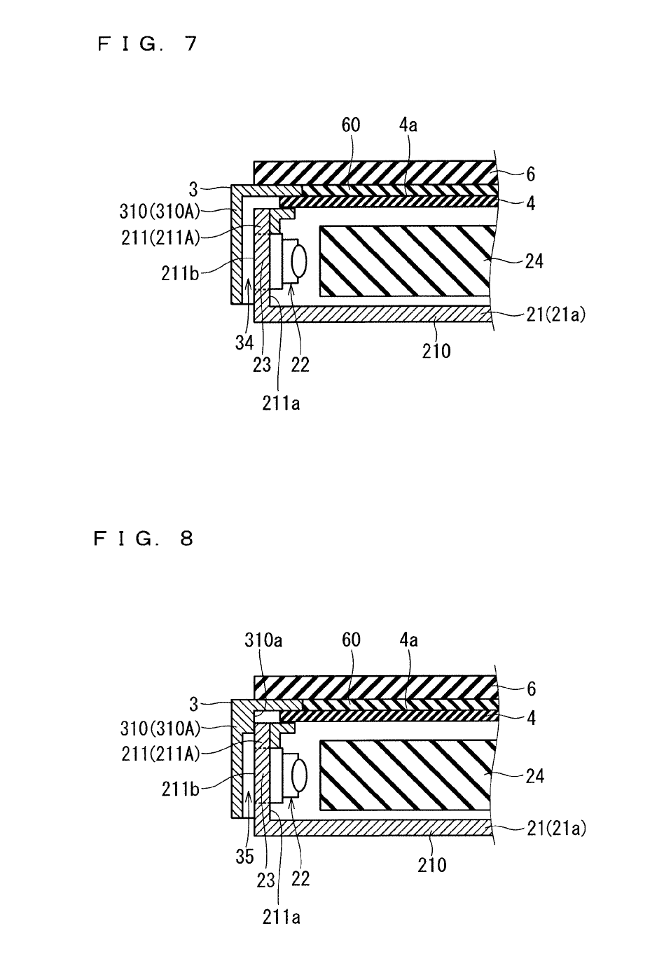

Next, a second modification as shown in FIG. 8 will be described. FIG. 8 is a partial cross sectional view of the display device 1 according to the second modification. As shown in FIG. 8, in the display device 1 according to the second modification, the inner surface 310a of the fixing housing side surface portion 310A of the fixing housing 3 is partially in contact with the outer surface 211b of the side surface portion 211A of the backlight back housing 21a. The inner surface 310a of the fixing housing side surface portion 310A is recessed in a portion facing the light-source disposed portion 23 of the side surface portion 211A. In other words, the inner surface 310a of the fixing housing side surface portion 310A is provided with a recessed portion 35 in the portion facing the light-source disposed portion 23 of the side surface portion 211A.

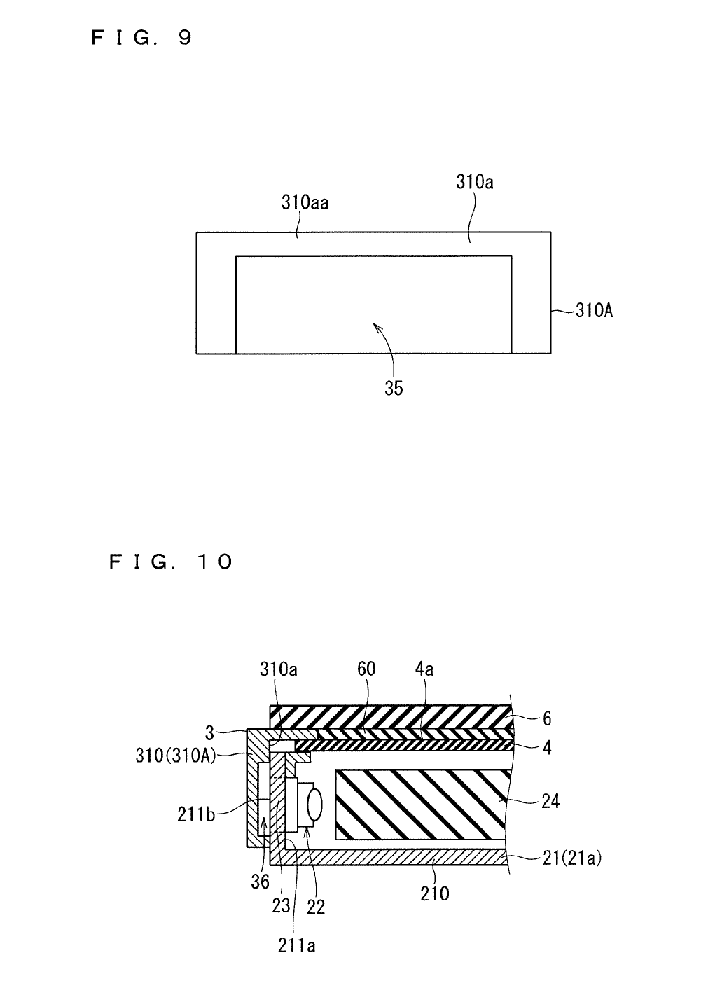

FIG. 9 is a plan view showing the fixing housing side surface portion 310A of the display device 1 according to the second modification as seen from the inner surface 310a of the fixing housing side surface portion 310A. As shown in FIG. 9, the recessed portion 35 is located toward the lower end of the inner surface 310a of the fixing housing side surface portion 310A. The fixing housing side surface portion 310A is in contact with the side surface portion 211A of the backlight back housing 21a at a peripheral portion 310a a except for a lower end portion in the inner surface 310a of the fixing housing side surface portion 310A.

On the other hand, among the four fixing housing side surface portions 310 of the fixing housing 3, the three fixing housing side surface portions 310 other than the fixing housing side surface portion 310A as a whole are in contact with each of the outer surfaces 211b of the three side surface portions 211 other than the side surface portion 211A among the four side surface portions 211 of the backlight back housing 21a, similarly to the first preferred embodiment.

In this manner, the inner surface 310a of the fixing housing side surface portion 310A is recessed in the portion facing the light-source disposed portion 23 of the side surface portion 211A, and thus the fixing housing side surface portion 310A and the light-source disposed portion 23 are not in contact with each other. Therefore, the heat generated by the light source 22 is difficult to be transmitted to the fixing housing 3. As a result, the heat is also difficult to be transmitted to the display part 4, and thus the deterioration of the display characteristics of the display part 4 due to the occurrence of the liquid crystal phase transition can be suppressed.

Lastly, a third modification as shown in FIG. 10 will be described. FIG. 10 is a partial cross sectional view of the display device 1 according to the third modification. As shown in FIG. 10, in the display device 1 according to the third modification similar to the display device 1 according to the second modification, the inner surface 310a of the fixing housing side surface portion 310A is recessed in a portion facing the light-source disposed portion 23 of the side surface portion 211A. In other words, the inner surface 310a of the fixing housing side surface portion 310A is provided with a recessed portion 36 in the portion facing the light-source disposed portion 23 of the side surface portion 211A. The display device 1 according to the third modification is provided with the recessed portion 36 instead of the recessed portion 35 in the display device 1 according to the second modification.

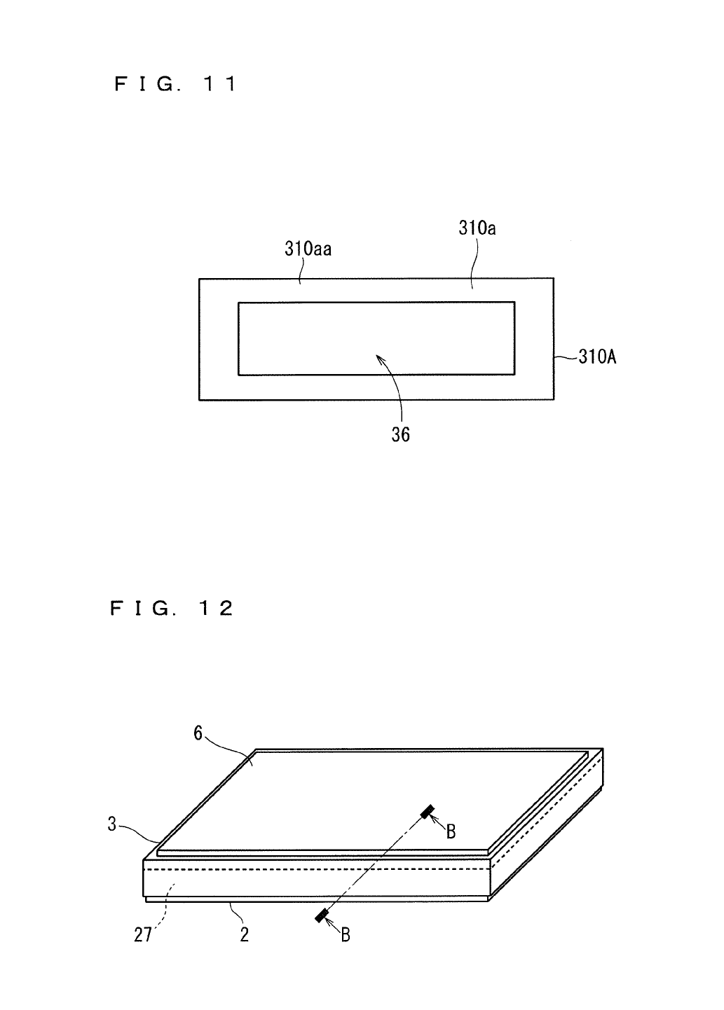

FIG. 11 is a plan view showing the fixing housing side surface portion 310A of the display device 1 according to the third modification as seen from the inner surface 310a of the fixing housing side surface portion 310A. As shown in FIG. 11, the recessed portion 36 is located in the center portion of the inner surface 310a of the fixing housing side surface portion 310A and does not reach the periphery of the inner surface 310a. The fixing housing side surface portion 310A is in contact with the side surface portion 211 A of the backlight back housing 21a in the entire region of the peripheral portion 310a a of the inner surface 310a of the fixing housing side surface portion 310A.

In this manner, also in the third modification, the inner surface 310a of the fixing housing side surface portion 310A is recessed in the portion facing the light-source disposed portion 23 of the side surface portion 211A, and thus the fixing housing side surface portion 310A and the light-source disposed portion 23 are not in contact with each other. Therefore, the heat generated by the light source 22 is difficult to be transmitted to the fixing housing 3. As a result, the heat is also difficult to be transmitted to the display part 4, and thus the deterioration of the display characteristics of the display part 4 due to the occurrence of the liquid crystal phase transition can be suppressed.

### Second Preferred Embodiment

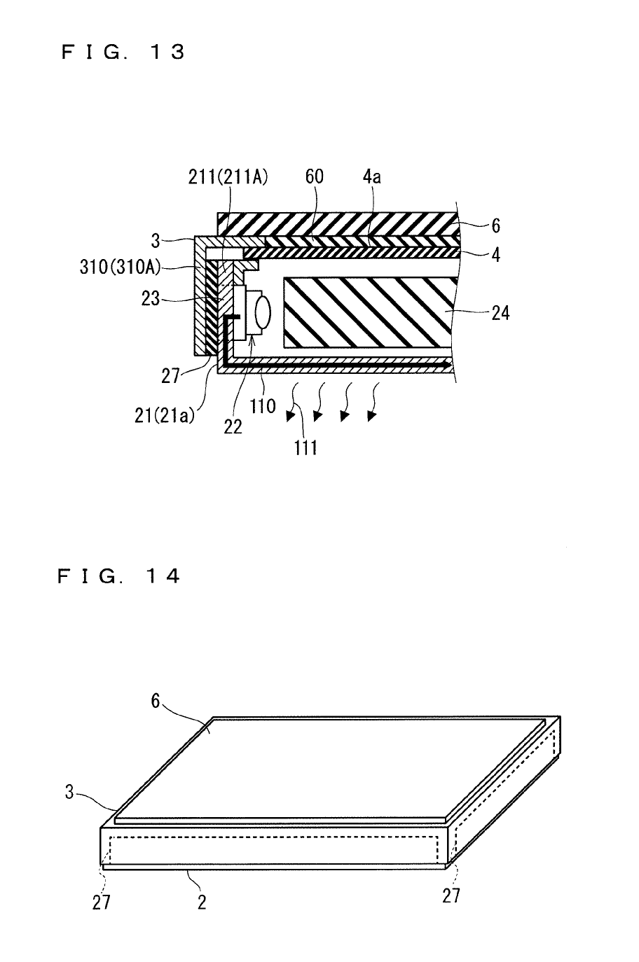

In a second preferred embodiment, a heat insulator 27 is provided between the fixing housing 3 and the backlight housing 21 to make the heat generated by the light source 22 more difficult to be transmitted to the fixing housing 3. The display device 1 according to the second preferred embodiment will be described with reference to FIGS. 12 and 13. FIG. 12 is a perspective view showing the display device 1 according to the second preferred embodiment. FIG. 13 is a partial enlarged view of a cross sectional structure of the display device 1 taken along a B-B line shown in FIG. 12.

As shown in FIGS. 12 and 13, the heat insulator 27 is located between the four side surface portions 310 of the fixing housing 3 and the four side surface portions 211 of the backlight back housing 21a. In other words, the heat insulator 27 is located between the portion, which faces the backlight back housing 21a, of the fixing housing 3 and the backlight back housing 21a. The heat insulator 27 is located so as to surround all of the four side surface portions 310 of the fixing housing 3. Thus, the fixing housing 3 and the backlight housing 21 are not in contact with each other. It suffices that the heat insulator 27 suppresses transmission of heat. The heat insulator 27 may be formed of, for example, a material having a porous structure, a material having a fibrous structure, a powdery and granular material, or a composite multilayer foil material.

In this manner, the heat insulator 27 is located between the fixing housing 3 and the backlight back housing 21a, so that the heat generated by the light source 22 is more difficult to be transmitted from the backlight back housing 21a to the fixing housing 3. Therefore, the heat is also difficult to be transmitted to the display part 4, and thus the deterioration of the display characteristics of the display part 4 due to the occurrence of the liquid crystal phase transition can be suppressed.

Moreover, as in the preferred embodiment, in a case where the heat insulator 27 reliably prevents the fixing housing 3 and the backlight back housing 21a from contacting each other, the heat generated by the light source 22 is made more difficult to be transmitted from the backlight back housing 21a to the fixing housing 3. Thus, in this case, the deterioration of the display characteristics of the display part 4 can be suppressed. In the example as described above, the cover member 6 is provided on the fixing housing 3 and the display surface 4a of the display part 4. However, similarly to the first preferred embodiment as mentioned above, the cover member 6 may be provided only on the fixing housing 3 or only on the display surface 4a of the display part 4.

The heat insulator 27 may not be located in the entire range from the fixing housing 3 to the backlight back housing 21a. FIG. 14 is a perspective view showing a modification of a display device according to the second preferred embodiment. In the display device 1 as shown in FIG. 14, the four heat insulators 27 separated from one another are each located on the inner surfaces of the four fixing housing side surface portions 310 of the fixing housing 3. In this manner, even if the heat insulator 27 is not located in the entire region from the fixing housing 3 to the backlight back housing 21a, the fixing housing 3 and the backlight back housing 21a can also be in non-contact with each other similarly to the preferred embodiment.

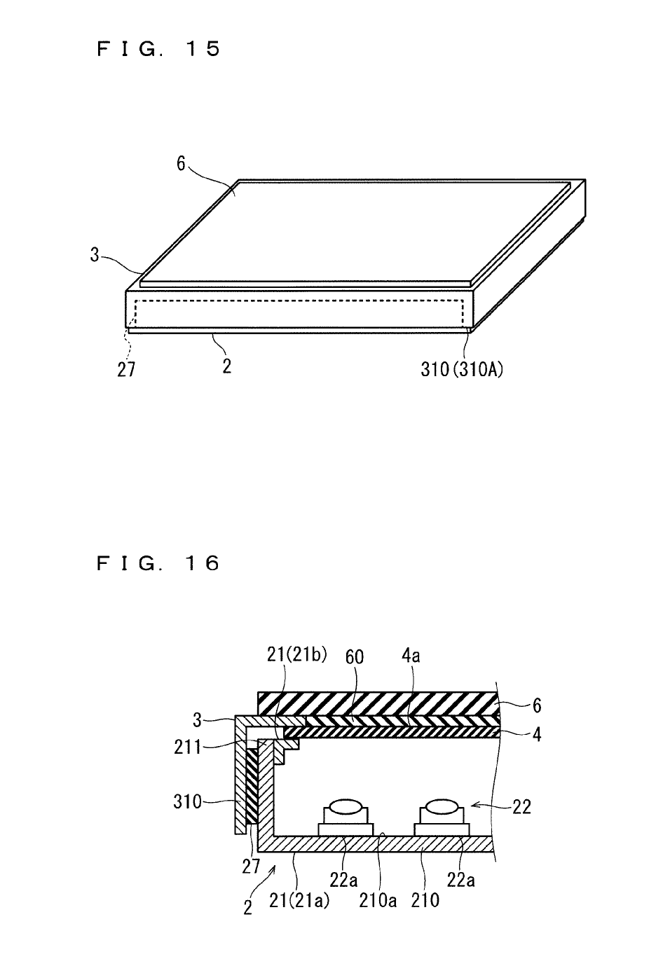

The fixing housing 3 and the backlight back housing 21a may not be in non-contact with each other. For example, as shown in FIG. 15, among the four fixing housing side surface portions 310 of the fixing housing 3, the heat insulator 27 is located only in the fixing housing side surface portion 310A, which faces the side surface portion 211A having the light-source disposed portion 23, of the backlight back housing 21a, and the other three fixing housing side surface portions 310 may be in contact with the backlight back housing 21a. In a case where the heat insulator 27 is located between the facing part, which faces the light-source disposed portion 23, of the fixing housing 3 and the light-source disposed portion 23, the heat is difficult to be transmitted from the light-source disposed portion 23 whose temperature is increased due to the heat generated by the light source 22 to the portion, which faces the light-source disposed portion 23, of the fixing housing 3, so that the heat generated by the light source 22 is more difficult to be transmitted to the fixing housing 3. Thus, the deterioration of the display characteristics of the display part 4 can be further suppressed.

The backlight part 2 may be a direct-lighting backlight part instead of an edge incident light type (side light type) backlight part. When the direct-lighting backlight part 2 is used, the light guide body 24 and the reflective sheet 25 are not needed. FIG. 16 is a partial cross sectional view of the display device 1 according to the second preferred embodiment in a case where the display device 1 adopts the direct-lighting backlight part 2. As shown in FIG. 16, in the direct-lighting backlight part 2, the light source 22 is located on the inner surface 210a of the bottom surface portion 210 of the backlight back housing 21a.

According to the present invention, the above preferred embodiments can be arbitrarily combined, or each preferred embodiment can be appropriately varied or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device, comprising:
a display part;
a backlight part that has a light source and a backlight housing in which said light source is located on an inner surface of a side surface portion; and
a fixing housing that has an opening portion exposing a display surface of said display part and fixes said display part and said backlight part to each other,
wherein said fixing housing is not in contact with a light-source disposed portion in said side surface portion of said backlight housing, said light-source disposed portion having said light source located thereon.

2. The display device according to claim 1, wherein
said fixing housing has a fixing housing side surface portion being in contact with an outer surface of said side surface portion of said backlight housing, and
said fixing housing side surface portion has a notch portion provided in a portion facing said light-source disposed portion.

3. The display device according to claim 1, wherein
said fixing housing has a fixing housing side surface portion facing an outer surface of said side surface portion of said backlight housing, and
to prevent contact between said fixing housing side surface portion and said side surface portion of said backlight housing, a gap is provided between said fixing housing side surface portion and said side surface portion.

4. The display device according to claim 1, wherein
said fixing housing has a fixing housing side surface portion being in contact with an outer surface of said side surface portion of said backlight housing, and
an inner surface of said fixing housing side surface portion is recessed in a portion facing said light-source disposed portion.

5. A display device, comprising:
a display part;
a backlight part that has a light source and a backlight housing in which said light source is located on an inner surface;
a fixing housing that has an opening portion exposing a display surface of said display part and fixes said display part and said backlight part to each other; and
a heat insulator located between said fixing housing and said backlight housing.

6. The display device according to claim 5, wherein
said fixing housing has a facing portion facing a light-source disposed portion in said backlight housing, said light-source disposed portion having said light source located thereon, and
said heat insulator is located between said light-source disposed portion of said backlight housing and said facing part of said fixing housing.

7. The display device according to claim 1, further comprising a member provided on said display surface of said display part, said display surface being exposed from said opening portion of said fixing housing.

8. The display device according to claim 7, wherein said member is a protective member for protecting said display part or a touch panel.

9. The display device according to claim 5, further comprising a member provided on said display surface of said display part, said display surface being exposed from said opening portion of said fixing housing.

10. The display device according to claim 9, wherein said member is a protective member for protecting said display part or a touch panel.
